(19) United States
(12) Patent Application Publication
(10) Pub. No.: US 2020/0094420 A1
(43) Pub. Date: Mar. 26, 2020

(54) GRIPPER DEVICE WITH A PROTECTIVE UNIT

(71) Applicant: E. Zoller GmbH & Co. KG Einstell- und Messgeräte, Pleidelsheim (DE)

(72) Inventors: Alexander ZOLLER, Pleidelsheim (DE); Christian PFAU, Ingersheim (DE)

(21) Appl. No.: 16/570,224

(22) Filed: Sep. 13, 2019

(30) Foreign Application Priority Data
Sep. 17, 2018 (DE) 10 2018 122 703.5

(51) Int. Cl. B25J 15/08; B25J 19/06

(52) U.S. Cl. CPC B25J 15/08; B25J 19/06

(57) ABSTRACT

A gripper device includes at least one gripper unit which is at least designed to, in at least one work step, grip and/or move a tool and/or a tool holder with at least one tool, and at least one protective unit, which is designed to at least substantially encompass at least a work region of the tool at least in part during the work step. The protective unit is fastened, at least in part during the work step, at least to the gripper unit.

### PRIOR ART

The invention relates to a gripper device according to the preamble of claim 1.

Collaborative robots having a gripper device and having a protective unit, wherein the protective unit encompasses the entire gripper, are known from the prior art.

The object of the invention consists, in particular, in providing an apparatus according to the invention having improved characteristics in terms of interactivity between man and machine. The object is achieved according to the invention by virtue of the features of patent claim 1, while advantageous embodiments and refinements of the invention can be gathered from the subclaims.

### Advantages of the Invention

The invention is based on a gripper device having at least one gripper unit, which is at least designed to, in at least one work step, grip and/or move a tool and/or a tool holder with at least one tool, and having at least one protective unit, which is designed to at least substantially encompass at least a work region of the tool at least in part during the work step.

It is proposed that the protective unit is fastened, at least in part during the work step, at least to the gripper unit.

By a “gripper device” should be understood, in particular, an apparatus which is designed to preferably grip and/or move the tool. In particular, the gripper device is designed to grip and/or move the tool in an at least partially automated manner. By “in a partially automated manner” should be understood, in particular, that a gripping cycle and/or a motion cycle is controllable and/or programmable, in particular by a user. In particular, the gripper device has at least one gripper arm, which is designed to move the tool. Preferably, the gripper arm has at least one bearing unit, which, in particular, is designed to provide a relative rotational movement between two parts of the gripper arm. In particular, the gripper arm is designed, upon reception of the tool, to position the gripper unit relative to the tool. Preferably, the gripper arm is designed to move the tool with the gripper unit.

By a “gripper unit” should be understood, in particular, a unit which is designed to make direct contact with the tool. In particular, the gripper unit is merely designed to fix the tool and, in particular, by means of the gripper arm, move the tool. Preferably, the gripper unit is connected to the gripper arm. By “connected” should in this context be understood, in particular, a positive connection and/or a non-positive connection, such as, for example, by at least a screw connection and/or a rivet connection and/or a latching connection and/or a locking connection and/or the like. In particular, the gripper unit is coupled to the gripper arm via a joint.

By a “tool” should be understood, in particular, an element which is designed to machine and/or to alter, in particular to drill and/or to turn and/or to mill and/or to cut and/or to grind and/or the like, a component. Preferably, the tool is configured as a drill and/or as a milling cutter and/or as a cutting tool and/or as a further tool which appears sensible to the person skilled in the art, wherein the tool has, in particular, at least one cutting edge and/or tip and/or the like. By a “work region” of a tool should be understood, in particular, a region in which at least one cutting edge of the tool, preferably all cutting edges of the tool and/or tip and/or the like, is disposed. In particular, the work region of the tool is at least sharp and/or pointed and/or the like and, in particular, in the event of direct contact with the user and/or in the vicinity of the user, poses an injury risk. By a “tool holder” should be understood, in particular, a tool chuck, which is designed to hold and/or stabilize, in particular if the tool is measured and/or adjusted with an presetting and measuring apparatus. Preferably, the tool holder is designed for a mounting of the tool in a machine tool.

By a “work step” should be understood, in particular, a period of time in which the gripper device, at least in part, performs work. By “at least in part during the work step” should in this context be understood during, in particular, at least 20%, preferably at least 60%, advantageously at least 90% of the work step and, particularly advantageously, throughout the work step.

By a “protective unit” should be understood, in particular, a unit which is designed to at least substantially prevent any contact and/or touching by a user, and/or an object, with the tool, in particular with the work region of the tool. In particular, the protective unit has at least one protective element, which is designed to at least substantially prevent a physical penetration of the protective unit. By “to at least substantially encompass” should be understood, in particular, that at least substantially all normals of the faces of the work region at least intersect with the protective unit, wherein the protective unit encompasses the work region in particular to the extent of at least 50%, preferably at least 60%, advantageously at least 70%, and particularly advantageously at least 80%. Particularly preferredly, the protective unit is fastened only to the gripper unit. Alternatively and/or additionally, the gripper unit is in particular fastened, at least in part in the work step, to at least one further unit, in particular the gripper arm.

By “fastened” should in this context be understood, in particular, a positive connection and/or a non-positive connection, such as, for example, via a latching connection and/or a locking connection and/or a magnetic connection and/or a rivet connection and/or the like. In particular, the protective unit is configured such that in at least one operating state it is detachable, at least in part, from the gripper unit. In particular, the protective unit, preferably in a rest state of the gripper unit, can be removed from the gripper unit. In particular, the gripper device has at least one positioning unit, which is designed, prior to the work step and/or during the work step, to fasten the protective unit at least to the gripper unit. In particular, the positioning unit has at least one positioning arm, which, in an at least partially automated manner, fastens the protective unit in particular to the gripper unit. Alternatively, the protective unit is fastened prior to the work step and/or during the work step, by at least one user, at least to the gripper unit.

By “designed” should be understood, in particular, specially programmed, laid out and/or equipped. By an object being designed for a specific function should be understood, in particular, that the object fulfills and/or executes this specific function in at least one application state and/or operating state.

By virtue of the embodiment according to the invention, it can in particular be achieved that a user can work directly with the gripper device at least substantially without danger. Moreover, interactive working between man and machine can be enabled even with hazardous tools. In addition, the flexibility of the protective unit can advantageously be further improved. Furthermore, a simplification of the protective unit and/or protection of an operator can advantageously be achieved. Moreover, a universal usage of the protective unit on different gripper units can be further improved. In addition, the expense of a protective unit can advantageously be further reduced. Furthermore, space requirements for the protective unit can advantageously be greatly reduced.

In a further embodiment of the invention, it is proposed that a principal direction of extent of the protective unit is at least substantially constant in angle with respect to the gripper unit, in particular to a plane of principal extent of the gripper unit and/or a gripping plane of the gripping unit. Particularly preferredly, the protective unit, upon a movement of the gripper unit, moves along with it. By a “principal direction of extent” of an object should here be understood, in particular, a direction which runs parallel to the longest edge of the smallest geometric cuboid which only just fully encompasses the object. By a “gripping plane” should be understood, in particular, a plane which at least substantially has a straight line of movement of the gripping unit in the gripping of the tool. Preferably, the gripping plane is at least substantially perpendicular to a principal direction of extent of the tool in the work step in which the tool is gripped by the gripper unit. “Constant in angle” is meant to define, in particular, an orientation of a direction relative to a reference direction, wherein the direction and the reference direction, in particular viewed in one plane, form a constant angle, and the angle, in particular upon movement of the protective unit and/or of the gripper unit, has a maximum deviation of, in particular, less than 8°, advantageously less than 5° and, particularly advantageously, less than 2°. As a result, the complexity of the protective unit can advantageously be further reduced. In addition, the stability of the protective unit can advantageously be further improved. By a “plane of principal extent” of a structural unit should be understood, in particular, a plane which is parallel to the largest side face of the smallest imaginary cuboid which only just fully encompasses the structural unit, and, in particular, runs through the center point of the cuboid.

In addition, it is proposed that the protective unit is of at least substantially hood-shaped design. By “hood-shaped” should be understood, in particular, cylindrical, wherein preferably at least one end of the cylinder is at least substantially closed, wherein the cylinder is preferably closed with a tangential hemisphere. As a result, the complexity of the protective unit can advantageously be further reduced. In addition, by virtue of the rounded edges of the hood-shaped protective unit, additional endangerment of the operator can advantageously be minimized.

It is further proposed that the protective unit has at least one invariable opening, which is designed to receive the tool element. By “invariable” should be understood, in particular, that the size, in particular the area, of the opening is constant. Preferably, the opening of the protective unit is at least substantially parallel to the gripping plane of the gripper unit. By “substantially parallel” should here be understood, in particular, an orientation of a direction relative to a reference direction, in particular in one plane, wherein the direction, in relation to the reference direction, has a deviation in particular less than 8°, advantageously less than 5° and, particularly advantageously, less than 2°. In particular, the opening forms at least partially the end of the hood-shaped cylinder, in particular one end of the cylinder. As a result, reception of a tool by means of the gripping unit with the protective unit can advantageously be provided as easily as possible.

Moreover, it is proposed that the protective unit is embodied at least substantially in a one-piece implementation. A “one-piece implementation” is advantageously also to mean a one-part implementation. A “one-part implementation is in particular to mean formed in one piece. Preferably, the protective unit is produced from a single blank, a mass and/or a casting, particularly preferredly in an injection molding process, in particular a single-component and/or multicomponent injection molding process. As a result, the complexity of the protective unit can advantageously be further reduced. In addition, an increase in stability of the protective unit can advantageously be achieved. Moreover, the protection performance of the protective unit can advantageously be further improved.

In addition, it is proposed that the gripper unit has at least one gripper element, which is designed to grip the tool, wherein the protective unit is coupled at least substantially independently of the movement of the gripper element. By a “gripper element” should be understood, in particular, an element which is designed for fixing and/or clamping of the tool, for instance at least one finger of a dual-fingered or multi-fingered gripper, at least one magnetic element of a magnetic gripper, and/or a pneumatic gripping element. Preferably, the gripping plane is at least substantially formed by a straight line of movement of the gripper element, preferably by straight lines of movement of two gripper elements configured separate from one another. By “independently” should be understood, in particular, that the gripper element is configured such that it is at least substantially stationary relative to the protective unit. Preferably, the protective unit is statically fastened to the gripper unit, wherein the gripper element, for fixing and/or clamping of the tool, moves relative to the protective unit. As a result, the protection by the protective unit can hereby advantageously be improved. Optimal reliability of the protective unit can hereby advantageously be provided.

Alternatively, it is proposed that the gripper unit has at least a first gripper element and at least a second gripper element, wherein the first and the second gripper element are designed to clamp at least the tool, wherein the protective unit is fastened at least in part to the first gripper element and/or the second gripper element. In particular, the protective unit, upon movement of the first gripper element and/or of the second gripper element, moves at least partially along therewith. Reception of the tool can hereby advantageously be simplified.

Moreover, it is proposed that the protective unit has at least a first protective element, which is fastened to the first gripper element, and at least a second protective element, which is fastened at least to the second gripper element. In particular, the protective unit is of at least two-part configuration, wherein the first protective element and the second protective element at least partially, preferably fully, form the protective unit. Reception of the tool can hereby advantageously be further simplified. Moreover, optimally efficient movement of the protective unit can be provided.

In addition, it is proposed that the first gripper element and the second gripper element are coupled, in terms of movement, to the first protective element and/or the second protective element. By “motional coupling” should be understood, in particular, that, upon movement, the first and/or the second protective element moves along therewith, wherein kinetic energy is provided merely by the gripper element. In particular, by “motional coupling” should be understood that the movement of the first protective element and/or of the second protective element at least substantially corresponds to the movement of the first gripper element and/or of the second gripper element. In particular, the first protective element and/or the second protective element is connected to the gripper element via a joint and/or via a fixed connection, such as, for example, a screw connection and/or a rivet connection. As a result, optimization of the energy-efficient movement can advantageously be achieved. In addition, the reliability of the protective unit can advantageously be further improved.

Furthermore, it is proposed that, when the protective elements is opened and/or closed, a straight line of movement of the first protective element and/or of the second protective element is at least substantially parallel to a straight line of movement of the first gripper element and/or of the second gripper element. By a “straight line of movement” of an element, in particular of the first and/or of the second protective element, should be understood, in particular, a straight line along which the center of gravity of the element, upon movement, at least substantially moves. As a result, reception of the tool with the gripping unit from the side and from above can advantageously be provided. In addition, simple and efficient movement of the protective elements can advantageously be provided.

Moreover, it is proposed that the gripper device has at least one control unit, which is designed to recognize dimensions of the tool by means of a sensor and to control moving of the protective unit on the basis thereof. By a “control unit” should be understood, in particular, an electronic unit, which is preferably at least partially integrated in a control and/or regulating unit of a gripper device and which is preferably designed to control and/or regulate at least one movement of the first gripper element and/or of the second gripper element and/or of the protective unit. Preferably, the control unit comprises a computing unit and, in particular, additionally to the computing unit, a memory unit having a control and/or regulating program stored therein, which is designed to be executed by the computing unit. Preferably, the gripper unit has the sensor. Preferably, the control unit is designed to register, by means of the sensor, a collision prediction, and, on the basis thereof, control the protective unit. By “moving” should in this context be understood, in particular, closing and/or opening, and/or mounting of the protective unit onto the tool. As a result, better service life of the protective unit can advantageously be achieved. In addition, it can advantageously be achieved that the gripper unit can receive larger tools. Moreover, universal usage of the protective unit on different gripper units can be further improved.

In addition, it is proposed that the first protective element and/or the second protective element are at least substantially rotatably supported. By “rotatably” should be understood, in particular, pivotably, wherein the first protective element and/or the second protective element rotate at least about one rotational axis. In particular, the first protective element and/or the second protective element is fastened with a pivot joint to the gripper unit, in particular to the first gripper element and/or the second gripper element. As a result, the flexibility of the gripper unit and/or of the protective unit can advantageously be further improved.

Furthermore, it is proposed that the rotational axis of the first protective element is identical to the rotational axis of the second protective element. By “identical” should preferably be understood at least substantially identical. In particular, the rotational axis, upon rotation of the first and of the second protective element, is at least substantially fixed. Alternatively, the rotational axis of the first protective element and of the second protective element moves upon rotation of the first protective element and of the second protective element. As a result, simple rotation of the protective elements can advantageously be provided. In addition, the protection afforded by the first protective element and the second protective element can advantageously be further improved. Moreover, lateral approach of the tool with the gripper unit can advantageously be provided.

Moreover, a method with a gripper device is proposed, wherein, in at least one work step, at least a work region of the tool is encompassed in an at least substantially automated manner when a tool and/or a tool holder unit is gripped and/or moved. By “in an automated manner” should be understood, in particular, that a gripping cycle and/or a motion cycle is controllable and/or programmable, in particular by a user. In particular, the motion cycle in the work step is controlled at least substantially by the control unit.

As a result, it can advantageously be achieved that a user can work directly with the gripper device at least substantially without danger. Moreover, interactive working between man and machine can be enabled even with hazardous tools. In addition, the flexibility of the protective unit can advantageously be further improved. Furthermore, simplification of the protective unit and/or protection of an operator can advantageously be achieved. Moreover, universal usage of the protective unit on different gripper units can be further improved. In addition, the expense of a protective unit can advantageously be further reduced. Furthermore, space requirements of the protective unit can advantageously be greatly reduced.

In addition, a collaborative robot having a gripper device is proposed. By a “collaborative robot” should be understood, in particular, a cobot, which is designed to operate in the vicinity of humans and/or with humans. As a result, interactive working between man and machine can advantageously be enabled.

Furthermore, an presetting and measuring apparatus system comprising a gripper device is proposed. By an “presetting and measuring apparatus system” should be understood, in particular, a system which has at least one presetting and measuring apparatus apparatus, which measures and/or adjusts a tool, in particular with different parameters. In particular, the collaborative robot is designed to at least partially communicate and/or work with the presetting and measuring apparatus.

### DRAWINGS

Further advantages emerge from the following description of the drawings. In the drawings, an illustrative embodiment of the invention is represented. The drawings, the description and the claims contain numerous features in combination. A person skilled in the art will expediently also view the features individually and combine them into sensible further combinations.

In the drawings:

FIG. 1 shows an presetting and measuring apparatus system comprising a collaborative robot and comprising a gripper device,

FIG. 2 shows at least a part of the gripper device having a gripper unit and having a protective unit,

FIG. 3 shows at least a part of the gripper device having the gripper unit and having the protective unit, in a work step,

FIG. 4 shows a flow diagram of a method with the gripper device,

FIG. 5 shows at least a part of an alternative gripper device of a further illustrative embodiment having a gripper unit and having an alternative protective unit comprising at least a first protective element and a second protective element,

FIG. 6 shows at least a part of the alternative gripper device having the gripper unit and the alternative protective unit, in a work step,

FIG. 7 shows at least a part of the alternative gripper device in a top view, and

FIG. 8 shows at least a part of an additional alternative gripper device of an additional further illustrative embodiment having a gripper unit and having an additional alternative protective unit comprising at least a first protective element and a second protective element.

### DESCRIPTION OF THE ILLUSTRATIVE EMBODIMENTS

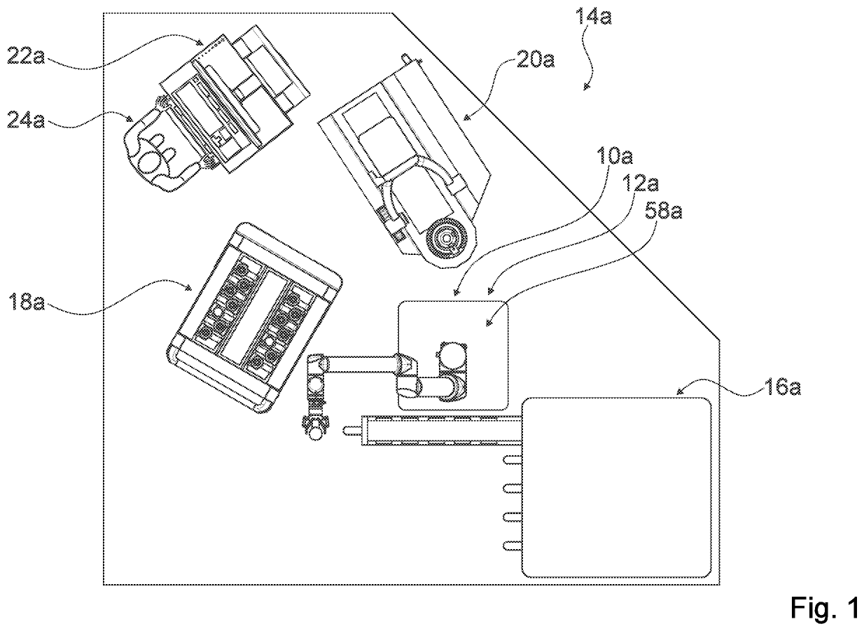

FIG. 1 shows an presetting and measuring apparatus system 14a. The presetting and measuring apparatus system 14a is at least designed to check the measurements of a tool 26a and/or adjust a position of the tool 26a in a tool holder. The presetting and measuring apparatus system 14a has at least one tool cabinet 16a. The tool cabinet 16a is designed for storage of the tool 26a. The tool cabinet 16a is designed for provision of the tool 26a. The presetting and measuring apparatus system 14a has at least one tool trolley 18a. The tool trolley 18a is mobile. The tool trolley 18a is designed to receive the tool 26a. The tool trolley 18a is designed to at least transport the tool 26a. The presetting and measuring apparatus system 14a has at least one presetting and measuring apparatus 20a. The presetting and measuring apparatus 20a is designed to at least measure and/or adjust the tool 26a. The presetting and measuring apparatus 20a is designed to receive at least one tool 26a. The presetting and measuring apparatus system 14a has at least one collaborative robot 12a. The presetting and measuring apparatus system 14a has at least one gripper device 10a. The collaborative robot 12a has at least the gripper device 10a. The collaborative robot 12a is designed to move the tool 26a between the units and/or devices of the presetting and measuring apparatus system 14a. The collaborative robot 12a moves the tool 26a between the tool cabinet 16a and the presetting and measuring apparatus 20a. The collaborative robot 12a moves between the tool trolley 18a and the presetting and measuring apparatus 20a. The collaborative robot 12a moves between the tool cabinet 16a and the tool trolley 18a. The presetting and measuring apparatus system 14a has at least one operating unit 22a. The operating unit 22a is designed to control the presetting and measuring apparatus 20a. The operating unit 22a is at least designed to control the tool cabinet 16a. The operating unit 22a is designed to control an output via the tool cabinet 16a. The operating unit 22a is at least designed to control a motion cycle of the collaborative robot 12a. A user 24a is at least intended to provide control parameters of the operating unit 22a. The operating unit 22a controls at least the collaborative robot 12a according to the control parameters.

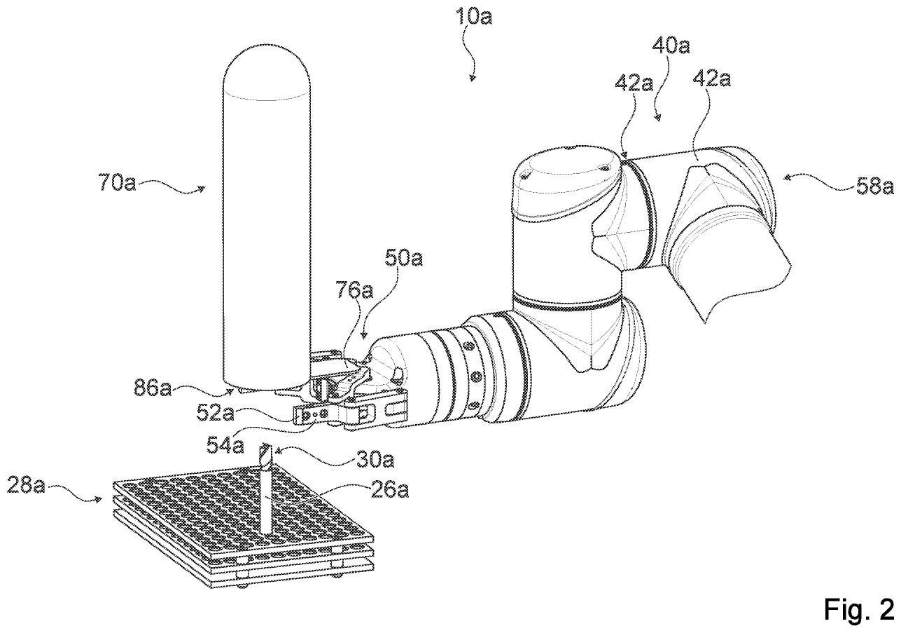

FIG. 2 shows at least in part a gripper device 10a. The gripper device 10a forms at least in part the collaborative robot 12a. The gripper device 10a has at least one gripper arm 40a. The gripper arm 40a has at least one bearing unit 42a. The bearing unit 42a is at least configured as a pivot joint. The bearing unit 42a is designed to provide a relative rotation between two joint rods 46a. For the sake of clarity, only a bearing unit 42a and a joint rod 46a are provided with reference symbols. The gripper arm 40a is designed to provide moving relative to the tool 26a. The bearing unit 42a is designed to provide moving of the gripper arm 40a relative to the tool 26a. The gripper device 10a has at least one gripper unit 50a. The gripper unit 50a is at least designed to, in a work step, grip a tool 26a. The gripper unit 50a is at least designed to, in the work step, move the tool 26a. The gripper unit 50a is designed to, in the work step, move the tool 26a by means of the gripper arm 40a. The gripper arm 40a is designed for relative positioning of the gripper unit 50a with respect to the tool 26a. The gripper unit 50a is designed to remove the tool 26a from a tool mounting 28a and/or insert it into the tool mounting 28a. The gripper unit 50a is designed to remove the tool 26a from a tool holder (not shown) and/or insert it into the tool holder.

Alternatively or additionally, the gripper unit 50a is designed to, in a work step, grip the tool holder with the tool 26a. The gripper unit 50a is at least designed to, in the work step, move the tool holder with at least one tool 26a. The gripper unit 50a is designed to, in the work step, move the tool holder with at least the tool 26a by means of the gripper arm 40a. The gripper arm 40a is designed for relative positioning of the gripper unit 50a with respect to the tool holder with at least one tool 26a. Alternatively or additionally, the gripper unit 50a is designed to, in a work step, grip the tool mounting 28a with the tool 26a. The gripper unit 50a is at least designed to move the tool mounting 28a with the tool 26a. The gripper unit 50a is designed to, in the work step, move the tool mounting 28a with at least the tool 26a by means of the gripper arm 40a.

The gripper unit 50a has at least one gripper element 52a. The gripper element 52a is designed to grip the tool 26a. The gripper element 52a is designed at least for direct reception of the tool 26a. When the tool 26a is moved and/or gripped with the gripper unit 50a, the gripper element 52a is at least substantially in direct contact with the tool 26a.

The gripper unit 50a has at least a first gripper element 54a. The gripper unit 50a has at least a second gripper element 56a. The first gripper element 54a and the second gripper element 56a are designed to clamp the tool 26a. The gripper unit 50a is designed to clamp the tool 26a between the first gripper element 54a and the second gripper element 56a. Upon reception of the tool 26a, the first gripper element 54a and the second gripper element 56a are in direct contact with the tool 26a.

The gripper device 10a has at least one protective unit 70a. The protective unit 70a is fastened, at least in part during the work step, at least to the gripper unit 50a. The protective unit 70a is fastened only to the gripper unit 50a. The protective unit 70a is fastened to the gripper unit 50a at least by means of a latching connection. Alternatively or additionally, the protective unit 70a is fastened to the gripper unit 50a by means of a screw connection. Alternatively or additionally, the protective unit 70a is fastened to the gripper unit 50a by means of a rivet connection. The gripper device 10a has at least one fastening element 76a. The protective unit 70a forms the fastening element 76a. The fastening element 76a is connected, at least substantially integrally, to the protective unit 70a. The fastening element 76a is designed to fasten at least the protective unit 70a on the gripper unit 50a. The fastening element 76a is designed to stabilize the protective unit 70a on the gripper unit 50a. The fastening element 76a is designed to position the protective unit 70a via the gripper element 52a. The fastening element 76a is designed to position the protective unit 70a via the first gripper element 54a and the second gripper element 56a. The protective unit 70a is coupled at least substantially independently of a movement of the gripper element 52a. The protective unit 70a is coupled at least substantially independently of a movement of the first gripper element 54a and of the second gripper element 56a.

A principal direction of extent of the protective unit 70a is at least substantially constant in angle with respect to a plane of principal extent of the gripper unit 50a. Upon movement of the gripper unit 50a, the protective unit 70a moves along with it. The relative positioning between the gripper unit 50a and the protective unit 70a is constant during the work step. A principal direction of extent of the protective unit 70a is at least substantially perpendicular to a gripping plane of the gripper unit 50a.

The protective unit 70a is of at least substantially hood-shaped design. The protective unit 70a is at least substantially cylindrical. The protective unit 70a has, at least substantially parallel to a gripping plane of the gripper unit 50a, at least one opening 86a. The opening 86a is invariable. The opening 86a is designed at least to receive the tool 26a. The opening 86a is at least substantially flat. The edges of the opening 86a are at least substantially arranged on one plane. The opening 86a forms at least in part a surface of the cylinder. The opening 86a forms in full a surface of the cylinder. The opening 86a is at least on a side facing toward the gripping element 52a. The protective unit 70a is closed at one end of the cylinder. The protective unit 70a is closed at the end with a tangential hemisphere. The protective unit 70a is at least substantially hollow. The protective unit 70a is at least substantially sheet-like. The walls of the protective unit 70a are at least substantially sheet-like. The walls of the protective unit 70a have at least substantially a constant thickness. The protective unit 70a is embodied at least substantially in a one-piece implementation. The protective unit 70a is at least substantially produced from one piece.

The gripper device 10a has at least one control unit 58a. The operating unit 22a controls the control unit 58a of the gripper device 10a. The control unit 58a is designed to register, by means of a sensor, a collision prediction. The control unit 58a is designed to control the protective unit 70a on the basis of the collision prediction. The control unit 58a is designed to at least substantially prevent gripping of the tool 26a in the event of a collision prediction. The gripper unit 50a has at least the sensor.

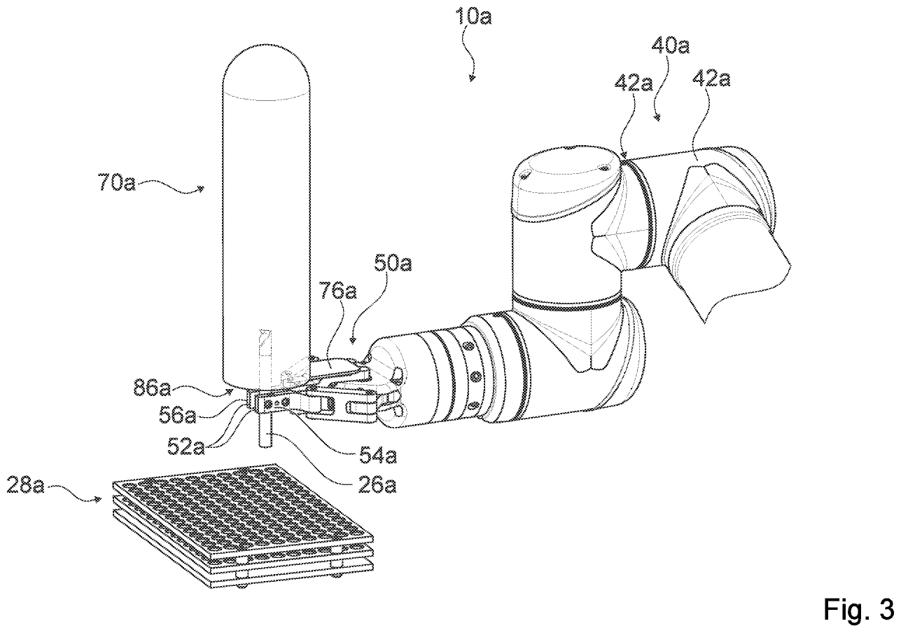

FIG. 3 shows the gripper device 10a having the gripper unit 50a during a work step. The protective unit 70a is designed to at least substantially encompass the tool 26a at least in part during the work step. The protective unit 70a is at least designed to at least substantially encompass at least a work region 30a of the tool 26a at least in part during the work step. The protective unit 70a is designed to encompass, throughout the work step, at least a work region 30a of the tool 26a. The protective unit 70a is designed to encompass the tool 26a, wherein a user 24a, during the work step, is separated at least from the work region 30a of the tool 26a. During the work step, the protective unit 70a is at least substantially positionally fixed relative to the tool 26a. During the work step, the center of gravity of the protective unit 70a is at least substantially the same distance from the center of gravity of the tool 26a.

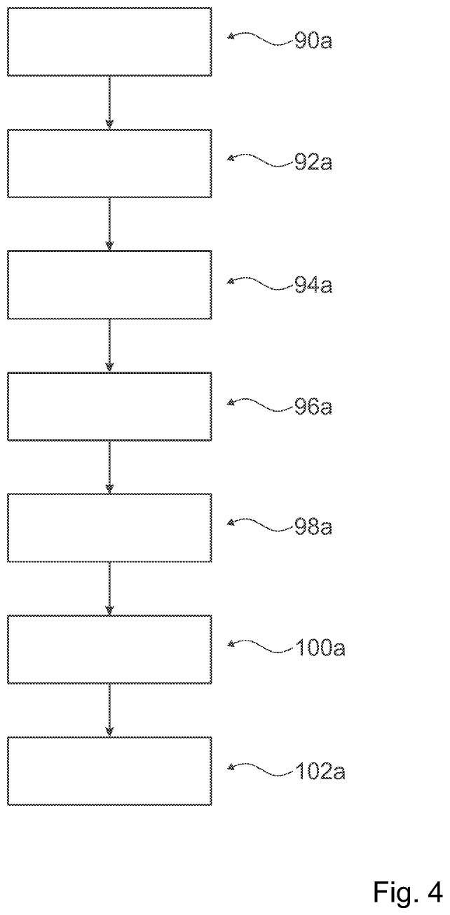

FIG. 4 shows a flow diagram of a method with the gripper device 10a. In at least one method step 90a, the protective unit 70a is fastened to the gripper unit 50a. In at least one further method step 92a, the gripper unit 50a is positioned next to or above the tool 26a in order to receive the tool 26a and/or the tool holder with at least one tool 26a. In at least one further method step 94a, the tool 26a is largely encompassed by the protective unit 70a. In the method step 94a, at least the work region 30a of the tool 26a is encompassed by the protective unit 70a. In at least one further method step 96a, the tool 26a is gripped with the gripper unit 50a. In the method step 96a, the tool 26a is clamped between the first gripper element 54a and the second gripper element 56a. In at least one further method step 98a, the gripper unit 50a, with the tool 26a encompassed by the protective unit 70a, is moved. In the method step 98a, the protective unit 70a is moved along with the tool 26a and the gripper unit 50a. In the method step 98a, the tool 26a is moved, for instance, from the tool cabinet 16a or the tool trolley 18a to the presetting and measuring apparatus 20a, or vice versa. In at least one further method step 100a, the tool 26a is released. In the method step 100a, the first gripper element 54a and the second gripper element 56a are opened. In at least one further method step 102a, the protective unit is removed from the tool by the gripper unit. In the method step 102a, the work region 30a of the tool 26a is made accessible. In the method step 102a, the protective unit 70a releases the tool 26a. At least one of the method steps 90a-102a forms a sub-step of the work step. Preferably, at least the method steps to which the reference symbols 96a, 98a and 100a are assigned are sub-steps of the work step. In the work step, the work region 30a of the tool 26a is encompassed in an automated manner by the protective unit 70a when the tool 26a is gripped and/or moved.

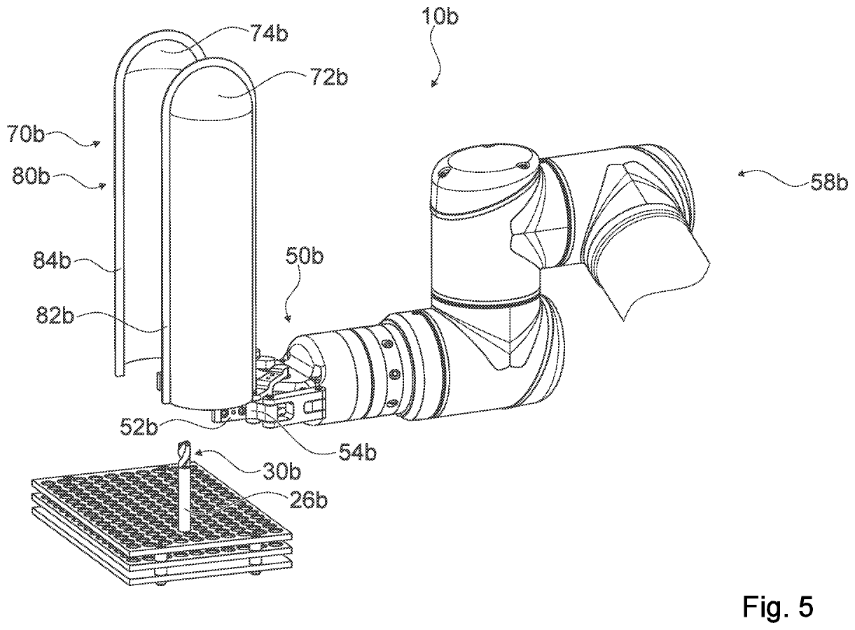

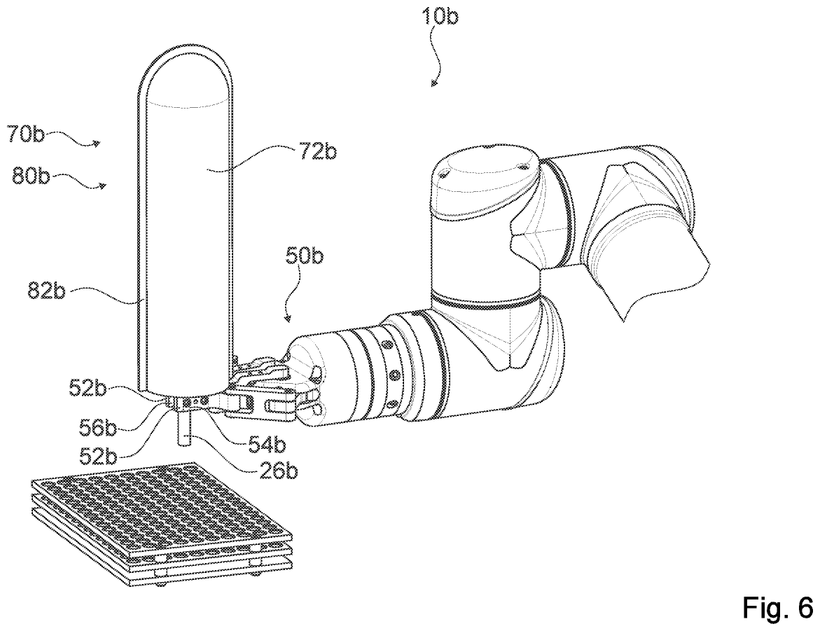

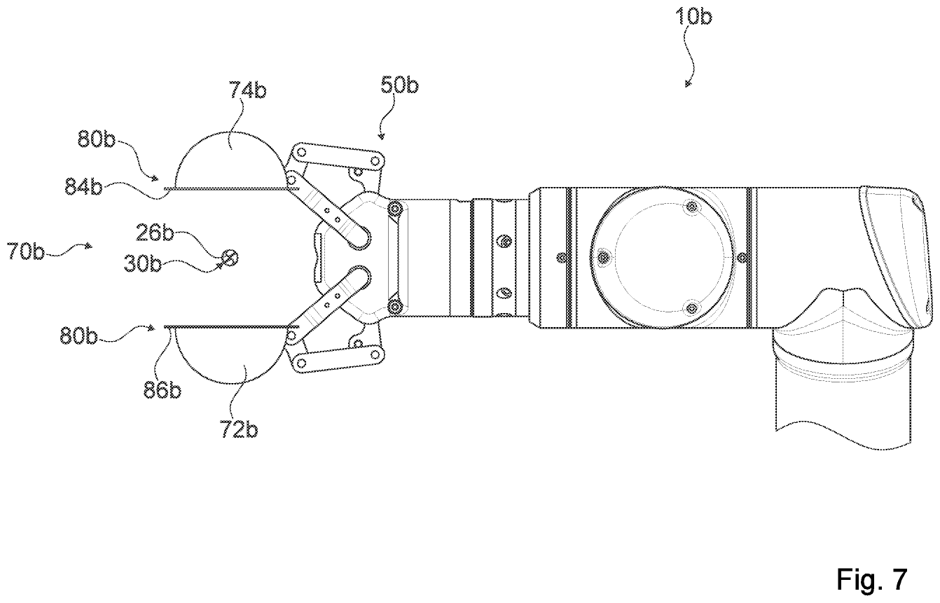

In FIGS. 5 to 8, further illustrative embodiments of the invention are shown. The following descriptions and the drawings are substantially confined to the differences between the illustrative embodiments, wherein, with respect to like-denoted components, in particular with respect to components having the same reference symbols, reference can essentially also be made to the drawings and/or the descriptions of the other illustrative embodiments, in particular FIGS. 1 to 4. In order to differentiate between the illustrative embodiments, the letter a is placed after the reference symbols of the illustrative embodiment of FIGS. 1 to 4. In the illustrative embodiments of FIGS. 5 to 8, the letter a is replaced by the letters b and c.

FIGS. 5 to 7 show a further illustrative embodiment of a gripper device 10b. The gripper device 10b has at least one gripper unit 50b. The gripper unit 50b has at least one gripper element 52b. The gripper unit 50b has at least a first gripper element 54b. The gripper unit 50b has at least a second gripper element 56b. The first gripper element 54b and the second gripper element 56b are designed to clamp at least one tool 26b. The first gripper element 54b moves at least substantially in one gripping plane. The second gripper element 56b moves at least substantially in one gripping plane. The gripper device 10b has at least one protective unit 70b. The protective unit 70b is at least substantially bipartite. The protective unit 70b is at least substantially divided along a cutting plane. The cutting plane runs at least in part through the center of gravity of the protective unit 70b. The cutting plane runs at least in part through a straight centerline of the cylinder. The protective unit 70b has at least a first protective element 72b. The first protective element 72b forms at least one half of the protective unit 70b. The protective unit 70b has at least a second protective element 74b. The second protective element 74b forms at least one half of the protective unit 70b. The first protective element 72b and the second protective element 74b form in the work step the protective unit 70b. The first protective element 72b and the second protective element 74b are at least substantially equally large. The first protective element 72b and the second protective element 74b are designed to at least partially open upon reception of the tool 26b. The first protective element 72b and the second protective element 74b are designed to at least partially close when the tool 26b is gripped.

The protective unit 70b is fastened at least to the first gripper element 54b. The protective unit 70b is fastened at least to the second gripper element 56b. The first protective element 72b is fastened at least to the first gripper element 54b. The second protective element 74b is fastened at least to the second gripper element 56b. The first gripper element 54b is coupled, in terms of movement, to the first protective element 72b. Upon movement of the first gripper element 54b, the first protective element 72b moves. The second gripper element 56b is coupled, in terms of movement, to the second protective element 74b. Upon movement of the second gripper element 56b, the second protective element 74b moves.

The first protective element 72b moves at least substantially along a straight line. The second protective element 74b moves at least substantially along a straight line. The first and the second protective element 74b move at least substantially on the same straight line. Upon opening of the protective elements 72b, 74b, a straight line of movement of the first protective element 72b is at least substantially parallel to a straight line of movement of the first gripper element 54b. Upon opening of the protective elements 72b, 74b, a straight line of movement of the second protective element 74b is at least substantially parallel to a straight line of movement of the first gripper element 54b. Upon opening of the protective elements 72b, 74b, a straight line of movement of the first protective element 72b is at least substantially parallel to a straight line of movement of the second gripper element 56b. Upon opening of the protective elements 72b, 74b, a straight line of movement of the second protective element 74b is at least substantially parallel to a straight line of movement of the second gripper element 56b. Upon closure of the protective elements 72b, 74b, a straight line of movement of the first protective element 72b is at least substantially parallel to a straight line of movement of the first gripper element 54b. Upon closure of the protective elements 72b, 74b, a straight line of movement of the second protective element 74b is at least substantially parallel to a straight line of movement of the first gripper element 54b. Upon closure of the protective elements 72b, 74b, a straight line of movement of the first protective element 72b is at least substantially parallel to a straight line of movement of the second gripper element 56b. Upon closure of the protective elements 72b, 74b, a straight line of movement of the second protective element 74b is at least substantially parallel to a straight line of movement of the second gripper element 56b. When the protective elements 72b, 74b are opened and/or closed, a straight line of movement of the first protective element 72b and/or of the second protective element 74b is at least substantially parallel to a gripping plane of the gripper unit 50b. Upon movement of the first protective element 72b, a straight line of movement is at least substantially perpendicular to a principal direction of extent of the gripper unit 50b. Upon movement of the second protective element 74b, a straight line of movement is at least substantially perpendicular to a principal direction of extent of the gripper unit 50b.

The protective unit 70b has at least one contact unit 80b. The contact unit 80b is designed to stabilize the protective unit 70b at least in part in the work step. The contact unit 80b is designed to mutually stabilize at least the first protective element 72b and the second protective element 74b at least in part in the work step. The first protective element 72b has at least a first contact element 82b. The second protective element 74b has at least a second contact element 84b. The first contact element 82b forms a contact frame. The second contact element 84b forms a contact frame. The first contact element 82b and the second contact element 84b are, at least in part in the work step, substantially in contact. The first contact element 82b and the second contact element 84b are, in the work step, in contact without a connection. Alternatively, the first contact element 82b and the second contact element 84b are, in the work step, at least partially connected. A transverse extent of the contact unit 80b is at least substantially perpendicular to the cylindrical surface of the protective unit 70b.

The gripper device 10b has at least one control unit 58b. The control unit 58b is designed to control movement of the gripper unit 50b. The control unit 58b is designed to control movement of the first gripper element 54b. The control unit 58b is designed to control movement of the second gripper element 56b. The control unit 58b is designed to control movement of the protective unit 70b. The control unit 58b is designed to control movement of the first protective element 72b. The control unit 58b is designed to control movement of the second protective element 74b. The control unit 58b is designed for positioning of the first protective element 72b and of the second protective element 74b relative to the tool 26b. The control unit 58b is designed to recognize dimensions of the tool 26b by means of a sensor. The gripper unit 50b has the sensor. The sensor is designed to register the dimensions of the tool 26b and to provide the dimensions of the control unit 58b. The control unit 58b is designed to move the protective unit 70b on the basis of the dimensions of the tool 26b. The control unit 58b is designed to move the first protective element 72b and the second protective element 74b on the basis of the dimensions of the tool 26b. The gripper unit 50b has at least the sensor. The control unit 58b is designed, at least in part in the work step, to at least substantially encompass a work region 30b of the tool 26b with the protective elements 72b, 74b. The control unit 58b is designed to adapt closure of the protective elements 72b, 74b at least to the dimension of the tool 26b.

The control unit 58b is designed to register a collision prediction by means of the sensor. The control unit 58b is designed to control the protective unit 70b on the basis of the collision prediction. The control unit 58b is designed to move the first protective element 72b and the second protective element 74b on the basis of the collision prediction. The control unit 58b is designed to at least substantially prevent gripping of the tool 26b in the event of a collision prediction.

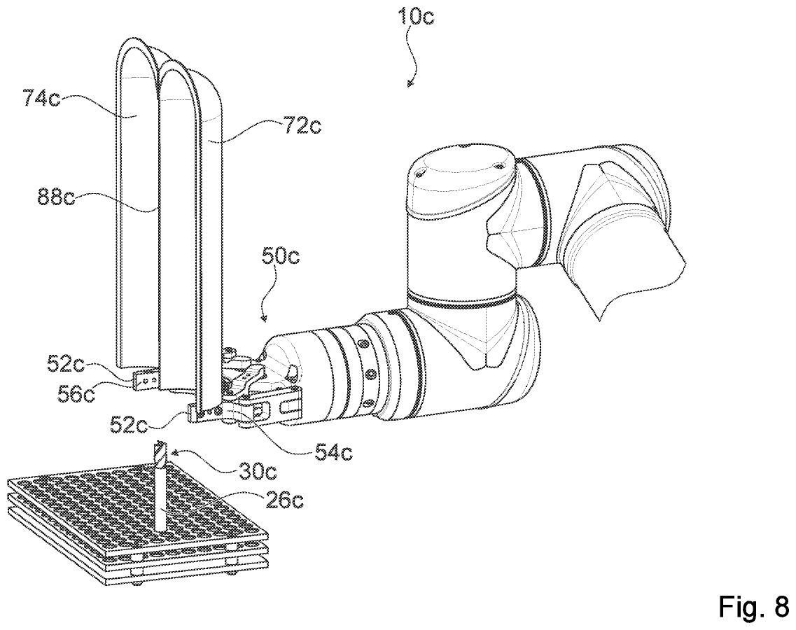

FIG. 8 shows at least one further illustrative embodiment of a gripper device 10c. The gripper device 10c has at least one protective unit 70c. The protective unit 70c has at least a first protective element 72c. The protective unit 70c has at least a second protective element 74c. The first protective element 72c is designed to at least substantially encompass at least a work region 30c of a tool 26c. The second protective element 74c is designed to at least substantially encompass at least the work region 30c of the tool 26c. The first protective element 72c is at least substantially rotatably supported. The second protective element 74c is at least substantially rotatably supported. The gripper device 10c has at least one gripper unit 50c. The first protective element 72c is at least substantially rotatably supported on the gripper unit 50c. The second protective element 74c is at least substantially rotatably supported on the gripper unit 50c. The gripper unit 50c has at least one gripper element 52c. The gripper unit 50c has at least a first gripper element 54c. The gripper unit 50c has at least a second gripper element 56c. The first protective element 72c is at least substantially rotatably fastened to the first gripper element 54c. The second protective element 74b is at least substantially rotatably fastened to the second gripper element 56c. The first protective element 72c rotates at least substantially about at least one rotational axis. The second protective element 74c rotates at least substantially about at least one further rotational axis.

The rotational axis of the first protective element 72c is identical to the rotational axis of the second protective element 74c. The rotational axis is at least substantially along an edge of the protective unit 70c. The rotational axis is at least substantially along a cutting edge of the first protective element 72c. The rotational axis is at least substantially along a cutting edge of the second protective element 74c. The first protective element 72c and the second protective element 74c close at least substantially via a folding mechanism.

Alternatively, the rotational axis of the first protective element 72c and the rotational axis of the second protective element 74c run at least substantially through the center of gravity of the protective unit 70c. Upon opening of the protective elements 72c, 74c, the protective elements 72c, 74c at least substantially rotate into each other. Upon closure of the protective elements 72c, 74c, the protective elements 72c, 74c at least substantially rotate apart.

The protective unit 70c has at least one hinge joint 88c. The hinge joint 88c is designed to at least rotatably connect the first protective element 72c to the second protective element 74c. The hinge joint 88c is at least substantially integrally connected to the first protective element 72c and the second protective element 74c. The hinge joint 88c has at least one bendable material. The protective unit 70c is at least substantially of integral configuration. Alternatively and/or additionally, the hinge joint 88c has at least one pivot element. The pivot element is connected to the first protective element 72c and the second protective element 74c.

Alternatively, upon closure and/or opening, the first protective element 72c and the second protective element 74c are coupled without a connection.

1. A gripper device having at least one gripper unit, which is at least designed, in at least one work step, to grip and/or move a tool and/or a tool holder with at least one tool, and having at least one protective unit, which is designed to at least substantially encompass at least a work region of the tool at least in part during the work step, wherein the protective unit is fastened, at least in part, during the work step, at least to the gripper unit.

2. The gripper device as claimed in claim 1, wherein a principal direction of extent of the protective unit is at least substantially constant in angle with respect to the gripper unit.

3. The gripper device as claimed in claim 1, wherein the protective unit is of at least substantially hood-shaped design.

4. The gripper device as claimed in claim 1, wherein the protective unit has at least one invariable opening, which is designed to receive the tool.

5. The gripper device as claimed in claim 1, wherein the protective unit is embodied at least partially in a one-piece implementation.

6. The gripper device as claimed in claim 1, wherein the gripper unit has at least one gripper element, which is designed to grip the tool, wherein the protective unit is coupled at least substantially independently from a movement of the gripper element.

7. The gripper device as claimed in claim 1, wherein the gripper unit has at least a first gripper element and at least a second gripper element, wherein the first gripper element and the second gripper element are designed to clamp at least the tool, wherein the protective unit is fastened at least in part to the first gripper element and/or the second gripper element.

8. The gripper device as claimed in claim 7, wherein the protective unit has at least a first protective element, which is fastened to the first gripper element, and at least a second protective element, which is fastened at least to the second gripper element.

9. The gripper device as claimed in claim 8, wherein the first gripper element and the second gripper element are, in terms of movement, coupled to the first protective element and/or the second protective element.

10. The gripper device as claimed in claim 9, wherein, when the protective elements are opened and/or closed, a straight line of movement of the first protective element and/or of the second protective element is at least substantially parallel to a straight line of movement of the first gripper element and/or of the second gripper element.

11. The gripper device as claimed in claim 1, further comprising at least one control unit, which is designed to recognize dimensions of the tool by means of a sensor and to control moving of the protective unit on the basis thereof.

12. The gripper device as claimed in claim 9, wherein the first protective element and/or the second protective element are/is at least substantially rotatably supported.

13. The gripper device as claimed in claim 12, wherein that the rotational axis of the first protective element is identical to the rotational axis of the second protective element.

14. A method with a gripper device as claimed in claim 1, wherein, in at least one work step, at least a work region of the tool is encompassed in an at least substantially automated manner when a tool and/or a tool holder is gripped and/or moved.

15. A collaborative robot having a gripper device as claimed in claim 1.

16. A presetting and measuring apparatus system comprising a gripper device as claimed in claim 1.
